(19) United States
(12) Patent Application Publication
(10) Pub. No.: US 2014/0234565 A1
(43) Pub. Date: Aug. 21, 2014

(54) SEALING MEMBRANE

(71) Applicant: Schlueter-Systems KG, Iserlohn (DE)

(72) Inventor: Werner SCHLUETER, Iserlohn (DE)

(73) Assignee: SCHLUETER-SYSTEMS KG, Iserlohn (DE)

(21) Appl. No.: 14/162,819

(22) Filed: Jan. 24, 2014

(30) Foreign Application Priority Data
Feb. 20, 2013 (DE) 10 2013 101 653.7

(51) Int. Cl. B32B 3/06; B32B 5/02; B32B 7/04

(52) U.S. Cl. CPC B32B 3/06; B32B 7/04; B32B 5/02
USPC 428/57; 428/192; 83/39

(57) ABSTRACT

A sealing membrane includes a waterproof layer; a self-adhesive adherent layer or a fleece or fabric layer which is provided on the bottom of the waterproof layer; and a fleece or fabric layer which is provided on the top of the waterproof layer; the sealing membrane being provided along one of its long side edges with projections formed by lugs which are respectively separated from one another by recesses.

### CROSS REFERENCE TO RELATED APPLICATIONS

Applicant claims priority under 35 U.S.C. §119 of German Application No. 10 2013 101 653.7 filed Feb. 20, 2013, the disclosure of which is incorporated by reference.

### BACKGROUND OF THE INVENTION

1. Field of the Invention

The present invention relates to a sealing membrane comprising a waterproof layer, a self-adhesive adherent layer or a fleece or fabric layer which is provided on the bottom of the waterproof layer, and a fleece or fabric layer which is provided on the top of the waterproof layer.

2. Description of the Related Art

These types of sealing membrane are fitted as a seal and vapour barrier in association with tiling. Areas of application are, for example, wet rooms, indoor swimming pools, wellness areas and industrial areas with increased air humidity. The self-adhesive adherent layer provided on the bottom of the waterproof layer serves to fix the sealing membrane to a substrate. Alternatively, a fleece or fabric layer can be provided with which the sealing membrane can be fixed to the substrate using a tile adhesive. The tile adhesive penetrates into the fleece or fabric layer and anchors in the latter so that the sealing membrane is securely connected to the substrate after the tile adhesive has dried. Tiles are laid over the top of the sealing membrane by the thin bed method using an appropriate tile adhesive. Here too the fleece or fabric layer arranged over the top of the waterproof layer serves to anchor the tile adhesive.

If a cross-over between two surfaces extending transversely, in particular perpendicularly to one another, such as for example the cross-over between a floor and a wall, is to be sealed, the sealing membrane is simply bent and fixed onto both surfaces. However, problems occur if one of the two surfaces is curved on the inside or the outside, such as for example in the case of a pillar standing on a substrate, a curved shower wall or the like, because the sealing membrane forms folds due to the curve, and this makes proper fixing of the sealing membrane and the subsequent tiling work considerably more difficult.

### SUMMARY OF THE INVENTION

On the basis of this prior art it is an object of the present invention to provide a sealing membrane of the type specified at the start which is specifically designed to seal a cross-over between two surfaces extending transversely, in particular perpendicularly to one another, one surface of which is curved on the inside and/or the outside.

In order to achieve this object the present invention provides a sealing membrane of the type specified at the start which is characterised in that it is provided along one of its long side edges with a plurality of projections formed like lugs which are respectively separated from one another by recesses. By means of these projections separated from one another by recesses the sealing membrane according to the invention can be guided without any problem along a curve on the inside and/or on the outside without any folds forming. Accordingly, one need not fear any negative impact upon the proper fixing of the sealing membrane or upon the subsequent tiling work.

The waterproof membrane is preferably produced from a soft plastic, in particular a soft polyethylene. A soft plastic provides the sealing membrane with elasticity and flexibility which facilitates handling.

The projections are advantageously arranged at regular intervals along the side edge, and this facilitates both production and laying of the sealing membrane.

According to one configuration of the present invention the recesses are made identically as regards form and dimensions, and this also has a positive effect upon the production and handling of the sealing membrane.

The projections preferably extend over ¼ to ¾ of the width of the sealing membrane, and this leads to good manageability of the sealing membrane.

The width of the sealing membrane is advantageously in the range of between 80 and 400 mm. With this width most applications are workable, and so the sealing membrane can be used flexibly for a wide range of applications.

According to one configuration of the present invention the recesses are polygonal in form, and in particular are triangular or trapezoidal. This leads to the projections tapering in the outwards direction, and this has a positive effect upon the manageability of the sealing membrane, as will be described in more detail in the following description. In this instance, the term “polygonal” is also intended to include a substantially polygonal form, the corner regions of which are provided at least partially with transition radii or curves.

The projections and the recesses are advantageously made identically as regards their form and dimensions, and this leads to production of the sealing membrane being very easy.

In the method for the production of a number n of sealing membranes provided with identical projections and recesses, n corresponding to a whole number multiple of the number 2, in a first step a starting sealing membrane is provided. This starting sealing membrane comprises an oblong waterproof layer, a self-adhesive adherent layer or a fleece or fabric layer which is provided on the bottom of the waterproof layer, and a fleece or fabric layer which is provided on the top of the waterproof layer. In a further step the recesses and the projections are produced by introducing contoured cutting lines corresponding to n/2 into the starting sealing membrane by offcut-free punching or cutting. Offcut-free processing is possible because, due to the identical form of the projections and recesses, during punching or cutting a section of a projection of the one membrane as well as a section of a recess of the other membrane is always produced.

If the number n is greater than 2, in a further step a separating line is respectively introduced between two adjacent contoured cutting lines by means of offcut-free punching or cutting in order to separate the sealing membranes which are still connected from one another, the separating line extending especially centrally between two adjacent contoured cutting lines in order to produce sealing membranes of the same width B.

When producing the recesses and the projections by punching or cutting, connecting bridges, which can be severed manually, can be left, and this leads to two respective sealing membranes still remaining connected to one another after the punching or cutting, and this can be advantageous in relation to the packaging and transport of the sealing membranes. The bridges can then be severed, for example torn apart, manually on site by a tiler in order to then work with the sealing membranes individually.

Furthermore, the present invention provides a sealing membrane arrangement with two sealing membranes arranged one over the other and fastened to one another according to the present invention, the sealing membranes being arranged offset in relation to one another in the longitudinal direction such that the projections of the one sealing membrane at least partially cover the recesses of the other sealing membrane. In this way proper and complete sealing of the cross-over between two surfaces to be sealed is achieved.

Preferably, the sealing membrane arrangement seals a cross-over between a surface having a curve on the inside and/or the outside, in particular in the form of a curved wall or a curved pillar, and a substrate extending transversely to the latter.

### BRIEF DESCRIPTION OF THE DRAWINGS

Further features and advantages of the present invention become clear from the following description with reference to the attached drawings. These show as follows:

FIG. 1 a diagrammatic top view of a sealing membrane according to a first embodiment of the present invention;

FIG. 2 a side view of the sealing membrane shown in FIG. 1;

FIG. 3 a diagrammatic top view of a sealing membrane according to a second embodiment of the present invention;

FIG. 4 a side view of the sealing membrane shown in FIG. 3;

FIG. 5 a diagrammatic top view of a starting sealing membrane from which, by punching or cutting, four of the sealing membranes shown in FIGS. 3 and 4 are produced;

FIG. 6 a diagrammatic perspective view of a sealing arrangement wherein a first sealing membrane of the type shown in FIGS. 3 and 4 is fastened between a pillar and a substrate in the cross-over region, and

FIG. 7 a diagrammatic perspective view, according to which a second sealing membrane is fastened to the first sealing membrane shown in FIG. 6.

### DETAILED DESCRIPTION OF PREFERRED EMBODIMENTS

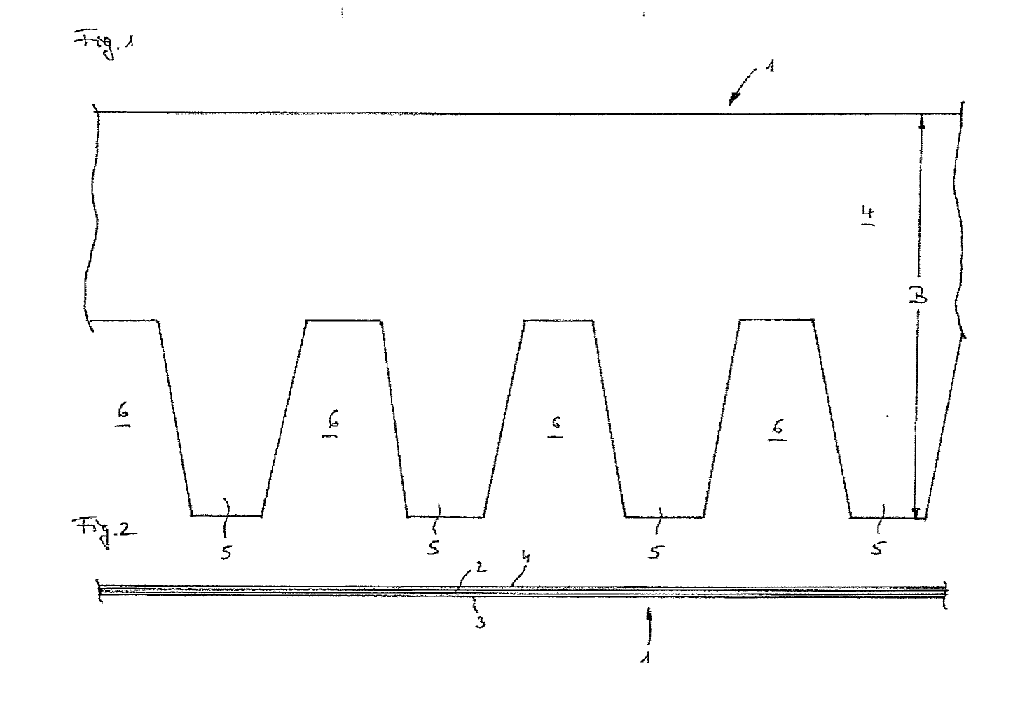

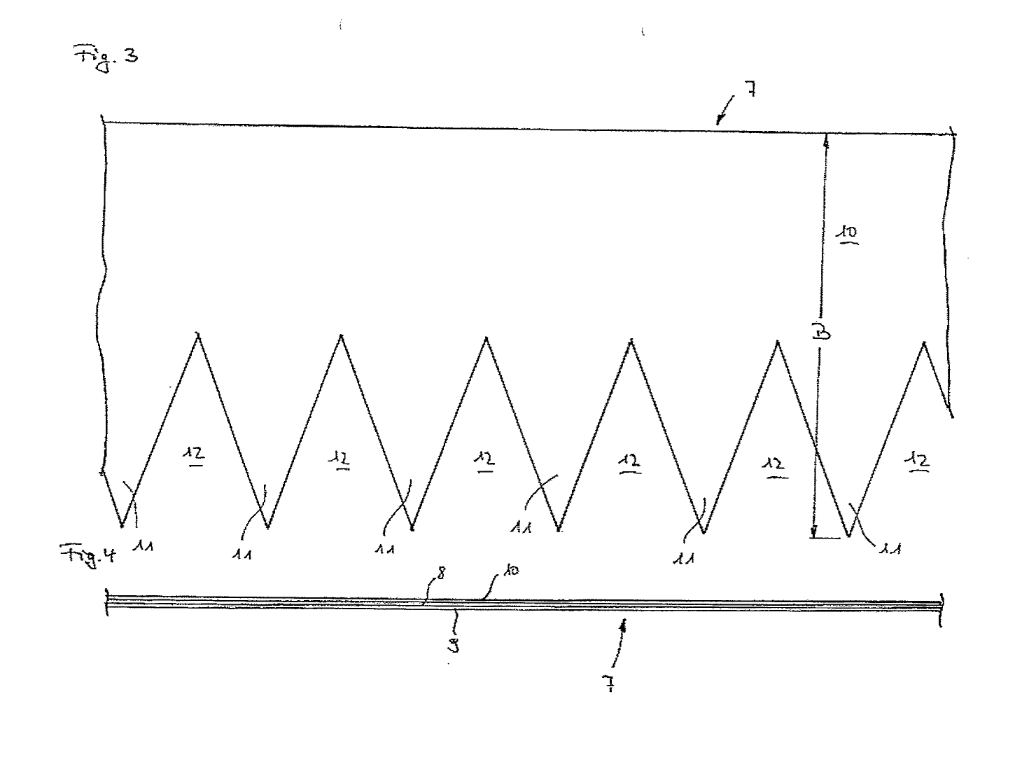

FIGS. 1 and 2 show a sealing membrane 1 according to one embodiment of the present invention. The sealing membrane 1 is of a width B which is in the range between 80 and 400 mm and consistently has a three-layer structure, the layers being arranged one over the other and being securely connected to one another. Arranged in the centre is a waterproof layer 2 which is produced from a soft plastic, such as for example soft polyethylene. Fastened to the bottom of the waterproof layer 2 is a fleece or fabric layer 3. Alternatively to the fleece or fabric layer 3 a self-adhesive adherent layer can be provided which is covered with a removeable covering layer made of plastic or the like for protection. A fleece or fabric layer 4 is provided on the top of the waterproof layer 2. Along one of its side edges arranged opposite one another and extending parallel to one another the sealing membrane 1 is provided with a plurality of projections 5 formed like lugs and which are respectively separated from one another by recesses 6. The projections 5 and the recesses 6 are arranged at regular intervals along the side edge and are made identically as regards their trapezoidal forms and dimensions. In this instance the projections 5 extend over half of the width B of the sealing membrane 1. Alternatively, the projections 5 can, however, also extend over between ¼ to ¾ of the width B of the sealing membrane 1.

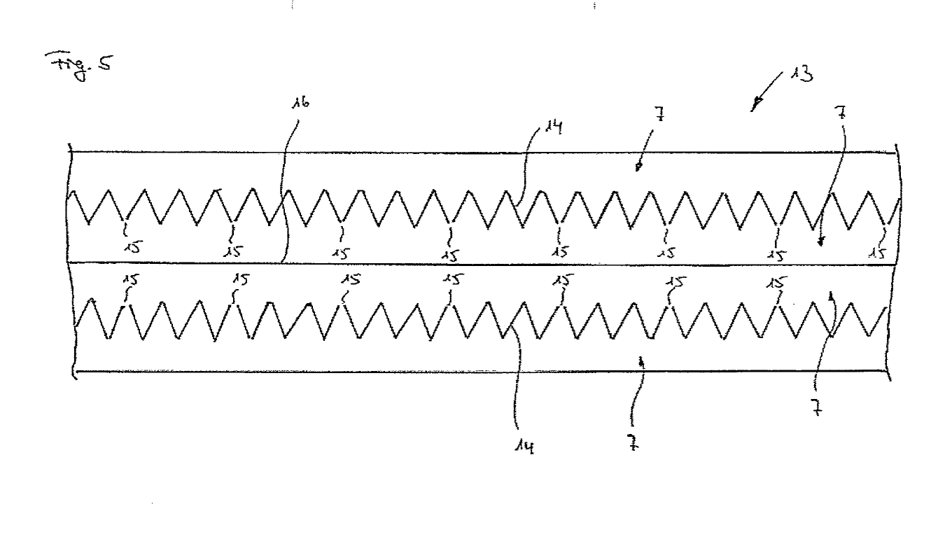

FIGS. 3 and 4 show a sealing membrane 7 according to a second embodiment of the present invention, the layered structure of which corresponds to that of the sealing membrane 1 shown in FIGS. 1 and 2. Therefore, the sealing membrane 7 also has a waterproof layer 8 which is respectively provided on its top and on its bottom with a fleece or fabric layer 9, 10. Along one of its two long side edges arranged parallel to one another the sealing membrane 7 is provided with a plurality of projections 11 made like lugs and which are respectively separated from one another by recesses 12. The projections 11 and the recesses 12 are arranged at regular intervals along the side edge and are made identically as regards their triangular form and as regards their dimensions. The projections 11 extend over half of the width B of the sealing membrane 7, the width B also being in the range from 80 to 400 mm here. Alternatively, the projections 11 can also extend over ¼ to ¾ of the width B of the sealing membrane 7.

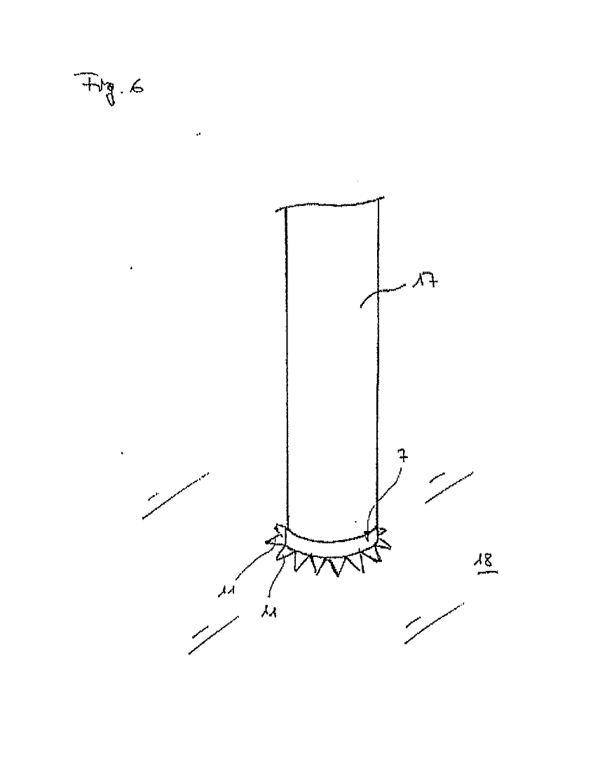

FIG. 5 shows a method for the production of four (n=4) sealing membranes 7. In a first step a starting sealing membrane 13 is provided which consists of the waterproof layer 8 and the two fleece or fabric layers 9, 10 and is of a width which corresponds to three times the width B of a single sealing membrane 7. In a further step on the one hand two (n/2) contoured cutting lines 14 for the production of the projections 11 and the recesses 12 of the respective sealing membranes 7 are introduced into the starting sealing membrane 13 by punching or cutting. Several connecting bridges 15 are left here which still connect to one another two adjacent sealing membranes 7 substantially separated from one another by the cutting lines 14. On the other hand a separating line 16 is introduced into the starting sealing membrane 13 by punching or cutting. In this way a total of four sealing membranes 7 are produced, two sealing membranes 7 respectively being held together by the connecting bridges 15. In a further step the sealing membranes 7 connected to one another can be cut to length and then be rolled up. They can then be brought to the fitting location in the rolled up state. Before fitting the sealing membranes 7 held together by the connecting bridges 15 can then be separated, for which purpose the connecting bridges 15 can for example be torn apart manually.

It should be clear that one can also dispense with producing the connecting bridges 15. In this case four separated sealing membranes 7, not connected to one another, are then produced. Furthermore, it should be clear that the number n of sealing membranes 7 can also have any whole number multiple of the number 2, i.e. n=2, 4, 6, 8, etc.

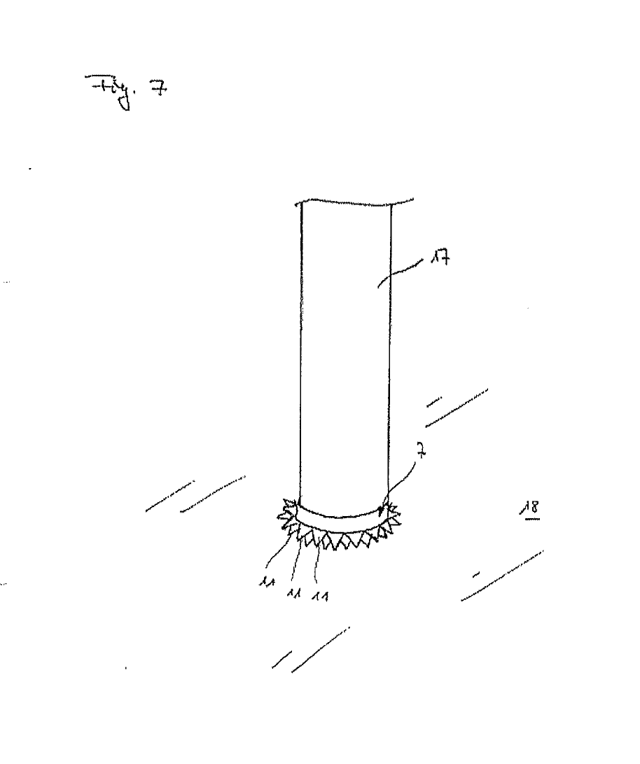

FIGS. 6 and 7 show a sealing membrane arrangement with which, for example, a cross-over between a curved surface of a vertical pillar 17 and a horizontal substrate 18 is sealed. In a first procedural step a tile adhesive is applied to the pillar and to the substrate. Next a first sealing membrane 7 is stuck onto the substrate 18 and onto the pillar 17 in such a manner that the projections 11 are fixed to the substrate 18 and to the remaining regions of the sealing membrane on the pillar 17. Then the sealing membrane 7 is cut to length so that the arrangement shown in FIG. 6 is produced. In a further step a further layer of tile adhesive is applied to the first sealing membrane 7 and to the substrate 18. Next a second sealing membrane 7 is stuck onto the first sealing membrane 7 offset in the longitudinal direction such that the projections 11 of the one sealing membrane 7 at least partially cover the recesses 12 of the other sealing membrane 7. After cutting the second sealing membrane 7 to length the arrangement shown in FIG. 7 is then produced. As can be seen in FIG. 7, the cross-over between the pillar 17 and the substrate 18 is now sealed. In a further step the substrate 18 can then be provided with conventional sealing membranes, the latter covering the remaining regions of the recesses 12 of the sealing membranes 7, by means of which complete sealing is achieved. Likewise, the pillar 17 can be covered with conventional sealing membranes for the purpose of sealing. In a further step tiles are finally laid over the covering or over the coverings.

### LIST OF REFERENCE NUMBERS

1 sealing membrane
2 waterproof layer
3 fleece or fabric layer
4 fleece or fabric layer
5 projections formed like lugs
6 recesses
7 sealing membrane
8 waterproof layer
9 fleece or fabric layer
10 fleece or fabric layer
11 projections formed like lugs
12 recesses
13 starting sealing membrane
14 cutting lines
15 connecting bridges
16 separating line
17 pillar
18 substrate

What is claimed is:

1. A sealing membrane (1; 7) comprising
a waterproof layer (2; 8);
a self-adhesive adherent layer or a fleece or fabric layer (3; 9) which is provided on the bottom of the waterproof layer (2; 8); and
a fleece or fabric layer (4; 10) which is provided on the top of the waterproof layer (2; 8);
the sealing membrane (1; 7) being provided along one of its long side edges with a plurality of projections (5; 11) formed like lugs which are respectively separated from one another by recesses (6; 12).

2. The sealing membrane (1; 7) according to claim 1, wherein the waterproof layer (2; 8) is produced from a soft plastic, in particular a soft polyethylene.

3. The sealing membrane (1; 7) according to claim 1, wherein the projections (5; 11) are arranged at regular intervals along the side edge.

4. The sealing membrane (1; 7) according to claim 1, wherein the recesses (6; 12) are made identically as regards form and dimensions.

5. The sealing membrane (1; 7) according to claim 1, wherein the projections (5; 11) extend over ¼ to ¾ of the width (B) of the sealing membrane (1; 7).

6. The sealing membrane (1; 7) according to claim 1, wherein the width (B) of the sealing membrane (1; 7) is in the range of between 80 and 400 mm.

7. The sealing membrane (1; 7) according to claim 1, wherein the recesses (6; 12) are polygonal in form, and in particular are triangular or trapezoidal.

8. The sealing membrane (1; 7) according to claim 1, wherein the projections (5; 11) and the recesses (6; 12) are made identically as regards their form and dimensions.

9. A method for the production a number n of sealing membranes (1; 7) according to claim 8, n corresponding to a whole number multiple of the number 2, the method comprising the steps:
providing a starting sealing membrane (13) with an oblong waterproof layer (2; 8), with a self-adhesive adherent layer or a fleece or fabric layer (3; 9) which is provided on the bottom of the waterproof layer (2; 8), and with a fleece or fabric layer (4; 10) which is provided on the top of the waterproof layer (2; 8);
producing the recesses (6; 12) and projections (5; 11) by introducing contoured cutting lines (14) corresponding to n/2 into the starting sealing membrane (13) by offcut-free punching or cutting;
and, if n is greater than 2, respectively introducing a separating line (16) between two adjacent contoured cutting lines (14) by means of offcut-free punching or cutting.

10. The method according to claim 9, wherein when producing the recesses (6; 12) and the projections (5; 11) by punching or cutting, connecting bridges (15), which can be severed manually, being left.

11. The sealing membrane arrangement with two sealing membranes (1; 7) arranged one over the other and fastened to one another according to claim 1, the sealing membranes (1; 7) being arranged offset in relation to one another in the longitudinal direction such that the projections (5; 11) of the one sealing membrane (1; 7) at least partially cover the recesses (6; 12) of the other sealing membrane (1; 7).

12. The sealing membrane arrangement according to claim 11, wherein the latter seals a cross-over between a surface having a curve on the inside and/or on the outside, in particular a curved wall or a curved pillar, and a substrate extending transversely to the latter.
